(19) United States
(12) Patent Application Publication
(10) Pub. No.: US 2021/0106859 A1
(43) Pub. Date: Apr. 15, 2021

(54) SAFETY MONITORING DEVICE FOR FIRE EXTINGUISHING SYSTEMS

(71) Applicant: RG Green Systems, S.L., Burgos (ES)

(72) Inventor: RAUL MELGOSA ARCOS, Burgos (ES)

(21) Appl. No.: 16/496,096

(22) PCT Filed: Feb. 1, 2018
(86) PCT No.: PCT/ES2018/070078

§ 371 Date: Sep. 20, 2019

(30) Foreign Application Priority Data
Mar. 21, 2017 (ES) U201730309

(51) Int. Cl. A62C 37/50; A62C 13/76; A62C 35/02; A62C 35/68

(52) U.S. Cl. CPC A62C 37/50; A62C 35/68; A62C 35/02; A62C 13/76

(57) ABSTRACT

Safety monitoring device for fire extinguishing systems includes a main body (1) couplable to any type of heads (2) of fire extinguishing systems screwed between the discharge valve (5) or device, that incorporates in general the fluid outlet (6), of as well electric, pneumatic, hydraulic or manual activation and the thread (4) of the valve, possessing a sensor (7), connected to an electronic board (8) and, through it, to a control room, programmable automaton or other control means of the extinguishing system, that detects whether the head (2) is correctly screwed and that, if it is not, sends a signal, through the electronic board (8), to the said control room of the installation.

### OBJECT OF THE INVENTION

The invention, as stated in the title of this specification, refers to a safety monitoring device for fire extinguishing systems that contributes, to the function to which it is designed, with advantages and characteristics of novelty to be disclosed thereafter.

The object of this invention refers to a device comprising, connected to an electronic board and to a power line, a tiny end of line incorporated in a housing adapted to be installed in the heads of fire extinguishing systems, of those constituted by bottles or reservoirs of gas, powder, water, foam, etc., operating by means of the activation de discharge valves or devices, with the aim to control, every moment, whether the electric, pneumatic, hydraulic or manual heads of the said systems are perfectly screwed, and warn, when they are not, the control room, programmable automaton or other control means that the fire extinguishing system has an improperly installed head.

### FIELD OF APPLICATION OF THE INVENTION

The field of application of this invention is within the sector of the industry engaged in manufacturing safety and control apparatuses and devices particularly focused in the field of fire extinguishing systems.

### BACKGROUND OF THE INVENTION

Despite some of the fire extinguishing systems possess a safety device that activates an alarm or warning in case of anomalies, in the installation of the heads, in most of them not even that, these devices simply control whether the head is properly installed or not, but do not detect its perfect installation, that means, the device would give a signal of correct position in the control room even though the head is simply located at its place but without it has been screwed, with the damaging consequences it would carry.

The objective of this invention is therefore, to develop a novelty safety device that, in addition to control that the head is installed on the bottles, cylinders or reservoirs of fluids with the discharge valve for extinguishing fires, control the correct location of the said head on the valve of the bottle, cylinder or reservoir, making sure that the head has been fully screwed, detecting that no length lacks screwing and, therefore, it is properly installed for its correct operation.

It shall be said, on the other hand that, as reference of the current state-of-the-art, at least the applicant is not aware of the existence of any other safety monitoring device for fire extinguishing systems or any other invention having a similar application that possesses technical and structural characteristics same or similar to those that are claimed herein.

### EXPLANATION OF THE INVENTION

The safety monitoring device for fire extinguishing systems that the invention proposes is therefore configured as a novelty within its field of application, because when implementing it the above objectives are satisfactorily reached, the characterizing details making it possible and distinguishing it conveniently appearing in the final claims attached hereto.

Concretely, what the invention proposes, as it was stated above, is an electronic device applicable to the heads of fire extinguishing systems, of gas, powder, water, foam, etc., the function of which is to activate discharge valves or devices, the aim of which is to control, every moment, that the said heads are perfectly installed and, if they are not, warn the control room, programmable automaton or other control means of the fire extinguishing system.

For this, the device comprises, connected to an electronic board and to a power line, a sensor, concretely a tiny push-button of end of line, incorporated in a housing adapted to be installed in every type of heads of existing fire extinguishing systems, of gas, powder, water, foam, etc., which are essential for activating discharge valves or devices of the extinguishing, controlling and suppressing fires systems. The device controls, every moment, whether the heads that can be electric, pneumatic, hydraulic, manuals, etc., are perfectly screwed, because if they are not, the end of line warns the control system that they are improperly installed.

Thus, it is avoided that, if the operators have made some error when installing the device, or if in the maintenance tasks the activation was left on, the possible consequences that a real discharge of the system occurs, or on the contrary if it was left dismounted, that the system is not activated in the event that an actual fire occurs

More specifically, the device of the invention possesses an internal nut that is perfectly coupled to the support of the heads, between the discharge valve and the activating head, as well as an external housing in which the wiring that connects the end of line is located.

In addition, the said housing is rotary, so that it is capable of rotating about the said internal nut to be able to place the device in the best fit position or in that which is most convenient for each installation.

The rotary housing, possesses a tightening bolt to be able to tightly screw the internal nut that, once correctly screwed, the bolt is removed, the housing is placed in the position sought and it is fastened with a locking set screw in order it remains fastened in the final position.

As for the electric components, they comprise a push-button of end of line that can be NA (open) or NC (closed), a printed board and a power strip from which four cables start, two that connect with the control room or system of the fire extinguishing installation for its supervision, and two others connecting with an end of line and this way complete the supervision circuit or to connect in series or parallel the following safety monitoring device incorporated in another or successive bottles, cylinders or reservoirs of the extinguishing system.

The safety monitoring device of the invention possesses a high precision and sensitivity detection, because it is capable of detecting that a device is improperly screwed with less than a screw thread missing, despite the device in fact would theoretically activate the extinguishing system, gives the signal of its improper installation for safety purpose, because if the heads are not perfectly placed, a bad operation of the system can be caused, and therefore the equipment would be not correctly activated.

It is important to point out this feature, because, as it was commented in above paragraphs, most of these control devices simply control whether the head is installed or not, but they do not detect its correct installation, that means that they give a signal of correct position in the control room even though the device is simply located at its place without in fact being screwed, with the consequences this would carry.

On the other hand, it may occur that the head being badly screwed is due to giving it a given orientation because of requirements of the installation, the device of this invention advantageously provides that this does not occur thanks to, as it was explained, it can rotate about itself to be placed in the position sought, whereby there is no problem for perfectly installing it until it reached its stop, it suffices to remove the locking elements and rotate them towards the best fitted orientation.

The safety monitoring device for fire extinguishing systems disclosed consists, therefore, of an innovating structure having characteristics unknown to this date for the purpose to which it is designed, reasons that joined to its practical utility, provide it sufficient ground to obtain the privilege of exclusivity applied for.

### DESCRIPTION OF THE DRAWINGS

To complement the description that is carried out and in order to assist to best understanding the characteristics of the invention, attached to this specification, as an integral part thereof, there is a set of drawings in which with illustrative and non-limitative purpose the following has been represented:

The figure number 1.—It shows an elevation view of an example of the safety monitoring device for fire extinguishing systems, object of the invention, which has been represented in position of use, that means, after it was incorporated to the bottle or reservoir of the extinguishing system, between the thread of the valve and the activating head, its general configuration and arrangement in the said system can be seen;

The figure number 2.—It shows a view in perspective of the exploded safety monitoring device for fire extinguishing systems, according to the invention, the main parts and elements it comprises can be seen in it; and

The figures numbers 3 and 4.—They show the device respective top views, newly represented in position of use, two possible positions of location among the number in which it can be placed can be seen.

### PREFERRED EMBODIMENT OF THE INVENTION

At the sight of the mentioned figures, and according to the numerals adopted in them, a non-limitative example of the safety monitoring device for fire extinguishing systems of the invention can be seen, that comprises the parts and elements that are stated and disclosed in detail thereafter.

Thus, as it can be seen in the said figures, the device of the invention comprises a main body (1) couplable to any type of activation heads (2), that can be of electric, pneumatic, hydraulic or manual activation, of fire extinguishing systems, for example bottles (3) cylinders or reservoirs, of gas, powder, water, foam, etc., screwed between the discharge valve (5) or device, and that generally incorporates the fluid outlet (6), which possesses a sensor (7), connected to an electronic board (8) and, through it, to a control room, programmable automaton or other control means of the extinguishing system (not shown in the figures), that detects whether the said head (2) is correctly screwed in the valve (5) or fire extinguishing system, that means, whether the discharge valve (5) or device has the activation head (2) perfectly screwed and, if it has not, it sends a signal to the said control room of the installation.

Preferably, the said sensor (7) consists in a push-button of end of line, NA (open) or NC (closed), that is arranged coupled, behind a protecting cover (18), so that it protrudes at the lower part of the main body (1), thus, when fully screwing the activation device (2) with the valve (5) the said sensor (7) is activated with the surface of the valve (5) and shuts the safety circuit.

The said sensor (7) is housed behind the said protecting cover (18), together with the electronic board (8) and a power strip (10) from which a wiring (11) starts that, through a gland (12), connects with the control room and, optionally, in series or parallel with other cylinders (3) or extinguishing systems of the same or different installation.

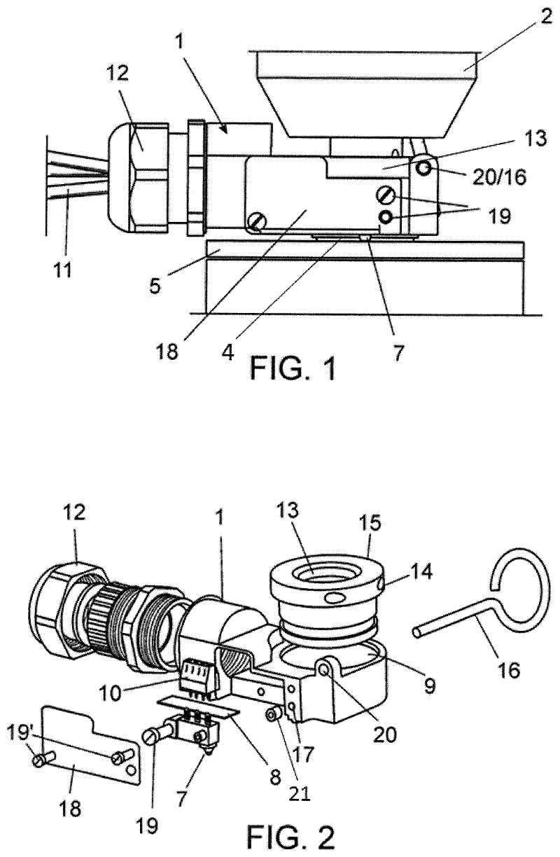

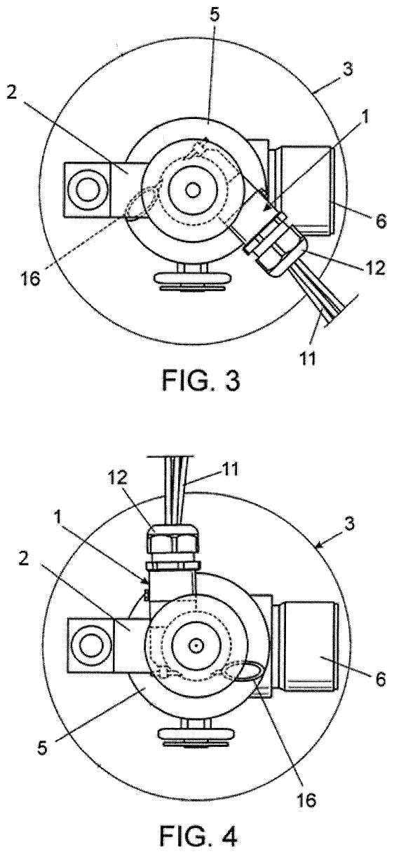

It is important to point out that, for coupling the main body (1) to the valve (5), of the bottle (3), reservoir or extinguishing system, an internal nut (13) has been provided with thread for its installation in the valve (5) that is installed in a housing (9) of the body of the main body (1) and allows it to freely rotate, in order to be able to locate it in any position and chose the one that best fit in each case, as it is shown in the FIGS. 3 and 4.

For screwing and locking the main body (1) the internal nut (13), possesses a thorough transversal hole (14) and an upper thickening (15), adapted to insert a tightening bolt (16) that, provided with a head to facilitate its handling, allows to apply the strength necessary for the said fastening. In addition, the main body (1) possesses a lug (20) in which the end of the said bolt (16) is inserted for locking. To fasten the main body (1), after the position sought has been chosen, it possesses a side thread (17) adapted for inserting a locking screw (21) that, when it crosses the housing wall (9) is interlocked, prisoner, in the internal nut (13).

Last, it shall be mentioned that the protecting cover (18) that covers the sensor (7), push-button of end of line, electronic board (8) and power strip (10) is laterally fastened on the body of the main body (1), by means of its respective tightening screw (19), allowing its easy dismounting to have access to them and allow the repair or replacement in case of deterioration, failure or bad contact.

The nature of this invention being sufficiently disclosed, as well as the way of implementing it, it is not deemed necessary to extend any longer its explanation in order that a person skilled in the art understands its extent and the advantages arising from it, and it is stated that, within its essence, it can be implemented in other embodiments that differ in detail from the one stated for example purpose, and to which also extends the protection applied for, provided that its fundamental principle is not altered, changed or modified.

1. A safety monitoring device for fire extinguishing systems, characterized in that it comprises a main body (1) couplable to any type of heads (2) of a fire extinguishing system that incorporates in general the fluid outlet (6), of as well electric, pneumatic, hydraulic or manual activation and the thread (4) of the valve, possessing a sensor (7), connected to an electronic board (8) and, through it, to a control room, programmable automaton or other control means of the extinguishing system, that detects whether the head (2) is correctly screwed and that, if it is not, sends a signal, through the electronic board (8), to the said control room of the installation.

2. The safety monitoring device for fire extinguishing systems, according to the claim 1, characterized in that the sensor (7) comprises a push-button of end of line, NA (open) or NC (closed), that is arranged coupled, so that it protrudes at the lower part of the main body (1), so that, when the device (1) is fully screwed in, the device (1) contacts the surface of the valve (5)

3. The safety monitoring device for fire extinguishing systems, according to the claim 1, characterized in that the sensor (7) is housed behind a protecting cover (18) laterally fastened on the body (1) by means of its respective screws (19), together with the electronic board (8) and a power strip (10) from which a wiring (11) starts that, through a gland (12), connect with the control room.

4. The safety monitoring device for fire extinguishing systems, according to the claim 3, characterized in that the wiring (11) connects in series with other bottles (3) or extinguishing systems of the same installation.

5. The safety monitoring device for fire extinguishing systems, according to claim 2, characterized in that for coupling the main body (1), screwed between the discharge valve (5) or device of the bottle (3) reservoir or extinguishing system, an internal nut (13) has been provided to the housing (9) of the main body (1) provided with a lower thread.

6. The safety monitoring device for fire extinguishing systems, according to the claim 5, characterized in that the internal nut (13) is coupled in the axis of the housing (9), so that the main body (1) freely rotates about it, to be able to place it in any position.

7. The safety monitoring device for fire extinguishing systems, according to the claim 5, characterized in that, for screw and locking the internal nut (13), this latter possesses a trough transversal hole (14), in a upper thickening (15), and the main body (1) a lug (20) in which a tightening and locking bolt (16) is inserted.

8. The safety monitoring device for fire extinguishing systems, according to claim 2, characterized in that, to fasten the main body (1) in the position sought, this latter possesses a thread (17) adapted for inserting a locking screw (21) that crosses the wall of the housing (9) and is interlocked, prisoner, in the internal nut (13).

9. The safety monitoring device of claim 1 wherein the fire extinguishing system, is one of a bottle (3) cylinder, a bottle reservoir, a gas cylinder, a powder cylinder, a water cylinder, a foam cylinder.

10. The safety monitoring device of claim 1 wherein the fire extinguishing system, is screwed between the discharge valve (5) or the device (1).

11. The safety monitoring device for fire extinguishing systems, according to claim 3, characterized in that for coupling the main body (1), screwed between the discharge valve (5) or device of the bottle (3) reservoir or extinguishing system, an internal nut (13) has been provided to the housing (9) of the main body (1) provided with a lower thread.

12. The safety monitoring device for fire extinguishing systems, according to claim 4, characterized in that for coupling the main body (1), screwed between the discharge valve (5) or device of the bottle (3) reservoir or extinguishing system, an internal nut (13) has been provided to the housing (9) of the main body (1) provided with a lower thread.

13. The safety monitoring device for fire extinguishing systems, according to the claim 6, characterized in that, for screw and locking the internal nut (13), this latter possesses a trough transversal hole (14), in a upper thickening (15), and the main body (1) a lug (20) in which a tightening and locking bolt (16) is inserted.

14. The safety monitoring device for fire extinguishing systems, according to claim 5, characterized in that, to fasten the main body (1) in the position sought, this latter possesses a thread (17) adapted for inserting a locking screw (21) that crosses the wall of the housing (9) and is interlocked, prisoner, in the internal nut (13).

14. The safety monitoring device for fire extinguishing systems, according to claim 6, characterized in that, to fasten the main body (1) in the position sought, this latter possesses a thread (17) adapted for inserting a locking screw (21) that crosses the wall of the housing (9) and is interlocked, prisoner, in the internal nut (13).
